(19) United States
(12) Patent Application Publication
(10) Pub. No.: US 2019/0011860 A1
(43) Pub. Date: Jan. 10, 2019

(54) IMAGE FORMING APPARATUS

(71) Applicant: CANON KABUSHIKI KAISHA, Tokyo (JP)

(72) Inventor: Jun Tomine, Abiko-shi (JP)

(21) Appl. No.: 16/019,572

(22) Filed: Jun. 27, 2018

(30) Foreign Application Priority Data
Jul. 7, 2017 (JP) 2017-134179

(51) Int. Cl. G03G 15/20; G03G 21/16; G03G 21/00; G03G 15/00

(52) U.S. Cl. CPC G03G 15/205; G03G 21/169; G03G 2221/0005; G03G 15/5008; G03G 21/0017

(57) ABSTRACT

An image forming apparatus includes a photosensitive member, an intermediary transfer member, an image forming portion, a cleaning blade, a motor, and an executing portion capable of executing an operation in an operating mode after an end of the image formation. In the operation in the operating mode, the executing portion is capable of executing a toner supplying operation, a stopping operation of the intermediary transfer member moving in the normal direction, and a reversely moving operation in which the intermediary transfer member is moved in an opposite direction to a normal direction and then is stopped. When the supplying operation is not executed, after an end of the image formation, the stopping operation is executed and then the reversely moving operation is executed. When the supplying operation is executed, after the supplying operation is carried out, the stopping operation is executed but the reversely moving operation is not executed.

### FIELD OF THE INVENTION AND RELATED ART

The present invention relates to an image forming apparatus, such as a copying machine, a facsimile machine or a printer, of an electrophotographic type, or an electrostatic recording type.

In the image forming apparatus of the electrophotographic type or the like, a deposited matter such as toner (transfer residual toner) or paper powder on an image bearing member such as a photosensitive member (electrophotographic photosensitive member) has been removed by a cleaning means. As the cleaning means, a cleaning blade which is a cleaning member contacting the image bearing member has been widely used.

In an image forming apparatus using the cleaning blade, a foreign matter such as the paper powder is sandwiched (nipped) between a free end of the cleaning blade and the image bearing member and thus a cleaning performance lowers, so that improper cleaning generates in some cases. Therefore, in Japanese Laid-Open Patent Application (JP-A) Hei-10-10939, when the image bearing member is stopped after an end of image formation, the image bearing member is rotated in an opposite direction (reverse rotation) to a direction (normal rotation) in an image forming period, whereby the foreign matter such as the paper powder sandwiched between the image bearing member and the cleaning blade is removed.

Further, in the image forming apparatus of the electrophotographic type or the like, an operation for supplying toner to a contact portion between the image bearing member and the cleaning blade is performed in a non-image forming period in some cases. For example, in the case where formation of an image in a high-temperature environment or with a low image ratio (print ratio) is continued, the toner in a developing device deteriorates in some cases. Therefore, in the case of such a situation, there is a method in which an image quality is maintained by increasing a proportion of fresh toner in the developing device by discharging (forcedly consuming) the toner from the developing device onto the image bearing member after the end of the image formation. Further, in the case where the formation of the image in the high-temperature environment or with the low image ratio (print ratio) is continued, a frictional force between the image bearing member and the cleaning blade increases in some instances. This is caused by a change in physical property of the cleaning blade in the high-temperature environment or by a decrease in amount of a lubricant (external additive of the toner) between the image bearing member and the cleaning blade due to continuation of the formation of the image with the low image ratio. Therefore, in the case of such a situation, there is a method in which after an end of the image formation, the lubricant is supplied between the image bearing member and the cleaning blade by supplying the toner to the contact portion between the image bearing member and the cleaning blade. As a result, it is possible to suppress inconveniences such as turning-up of the cleaning blade. Incidentally, also the toner discharged from the developing device in order to refresh the toner in the developing device has a function of supplying the lubricant to between the image bearing member and the cleaning blade by being supplied to the contact portion between the image bearing member and the cleaning blade.

In the case where a supplying operation for supplying the toner to the contact portion between the image bearing member and the cleaning blade is executed immediately before the image bearing member is stopped, when a reversely rotating operation for reversely rotating the image bearing member is performed when the image bearing member is stopped, simultaneously with removal of the foreign matter such as the paper powder sandwiched between the image bearing member and the cleaning blade, a part of the lubricant supplied to between the image bearing member and the cleaning blade is also removed. For that reason, when subsequent normal rotation is started, the frictional force between the image bearing member and the cleaning blade increases. A situation that the supplying operation of the toner to the contact portion between the image bearing member and the cleaning blade is performed after the end of the image formation is also a situation such that the inconveniences such as the turning-up of the cleaning blade is liable to occur. For that reason, as described above, in the case where the frictional force between the image bearing member and the cleaning blade increases when the subsequent normal rotation of the image bearing member is started, the inconveniences such as the turning-up occur in some instances.

On the other hand, JP-A 2007-79126 has proposed a method in which when the image bearing member is stopped, the toner is supplied to the image bearing member and normal rotation of the image bearing member is stopped before the toner reaches the contact portion between the image bearing member and the cleaning blade, and thereafter, the image bearing member is reversely rotated.

However, in the method of JP-A 2007-79126, the frictional force between the image bearing member and the cleaning blade is in a high state in a period from a start of subsequent rotation of the image bearing member until the toner supplied before a stop of the last rotation of the image bearing member reaches the contact portion between the image bearing member and the cleaning blade. For that reason, there is a liability that the inconveniences such as the turning-up of the cleaning blade occurs.

### SUMMARY OF THE INVENTION

According to an aspect of the present invention, there is provided an image forming apparatus comprising: a photosensitive member; an intermediary transfer member movable and having an endless shape; an image forming portion configured to carry out image formation in which a toner image is formed on a surface of the photosensitive member and thereafter is primary-transferred onto a surface of the intermediary transfer member and then is secondary-transferred onto a recording material; a cleaning blade contacting the surface of the intermediary transfer member at a contact portion and configured to remove a deposited matter deposited on the surface of the intermediary transfer member with movement of the intermediary transfer member; a motor configured to move the intermediary transfer member by being rotationally driven, wherein the motor is capable of moving the intermediary transfer member in a normal direction in which the intermediary transfer member moves in an image forming period and in an opposite direction to the normal direction; and an executing portion capable of executing an operation in an operating mode after an end of the image formation, wherein in the operation in the operating mode, the executing portion is capable of executing: a supplying operation in which toner is supplied to the contact portion by primary-transferring a supplying toner image onto the intermediary transfer member moving in the normal direction after an upstreammost portion, with respect to the normal direction, of a last toner image which is primary-transferred before the intermediary transfer member stops is primary-transferred onto the intermediary transfer member, a stopping operation in which the intermediary transfer member moving in the normal direction is stopped, and a reversely moving operation in which the intermediary transfer member is moved in the opposite direction and then is stopped, wherein a distance of movement of the intermediary transfer member in the opposite direction is not less than a distance of the contact portion with respect to a movement direction of the intermediary transfer member, wherein the executing portion executes the operation in the following manner depending on whether or not the supplying operation is executed: i) when the supplying operation is not executed, after an end of the image formation, the stopping operation is executed and then the reversely moving operation is executed, and ii) when the supplying operation is executed, after the supplying operation is carried out, the stopping operation is executed but the reversely moving operation is not executed.

According to another aspect of the present invention, there is provided an image forming apparatus comprising: a movable photosensitive member; an image forming portion configured to form an image by forming a toner image on a surface of the photosensitive member and thereafter by transferring the toner image onto a recording material; a cleaning blade contacting the surface of the photosensitive member at a contact portion and configured to remove a deposited matter deposited on the surface of the photosensitive member with movement of the photosensitive member; a motor configured to move the photosensitive member by being rotationally driven, wherein the motor is capable of moving the photosensitive member in a normal direction in which the photosensitive member moves in an image forming period and in an opposite direction to the normal direction; and an executing portion capable of executing an operation in an operating mode after an end of the image formation, wherein in the operation in the operating mode, the executing portion is capable of executing: a supplying operation in which toner is supplied to the contact portion by forming a supplying toner image on the photosensitive member moving in the normal direction after an upstreammost portion, with respect to the normal direction, of a last toner image which is primary-transferred before the photosensitive member stops is formed on the photosensitive member, a stopping operation in which the photosensitive member moving in the normal direction is stopped, and a reversely moving operation in which the photosensitive member is moved in the opposite direction and then is stopped, wherein a distance of movement of the photosensitive member in the opposite direction is not less than a distance of the contact portion with respect to a movement direction of the photosensitive member, wherein the executing portion executes the operation in the following manner depending on whether or not the supplying operation is executed: i) when the supplying operation is not executed, after an end of the image formation, the stopping operation is executed and then the reversely moving operation is executed, and ii) when the supplying operation is executed, after the supplying operation is carried out, the stopping operation is executed but the reversely moving operation is not executed.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic sectional view showing an image forming portion.

FIG. 3 is a block diagram showing a system structure of an image processing unit.

FIG. 4 is a block diagram showing a control mode of a principal part of the image forming apparatus.

FIG. 5 is a flowchart showing control of a discharging operation.

FIG. 6 is a graph for illustrating a temperature rise of a developer during continuous image formation.

FIG. 7 is a flowchart showing a procedure of the discharging operation.

FIG. 8 is a flowchart showing reverse rotation properness control.

### DESCRIPTION OF THE EMBODIMENTS

An image forming apparatus according to the present invention will be specifically described with reference to the drawings.

### Embodiment 1

### 1. General Constitution and Operation of Image Forming Apparatus

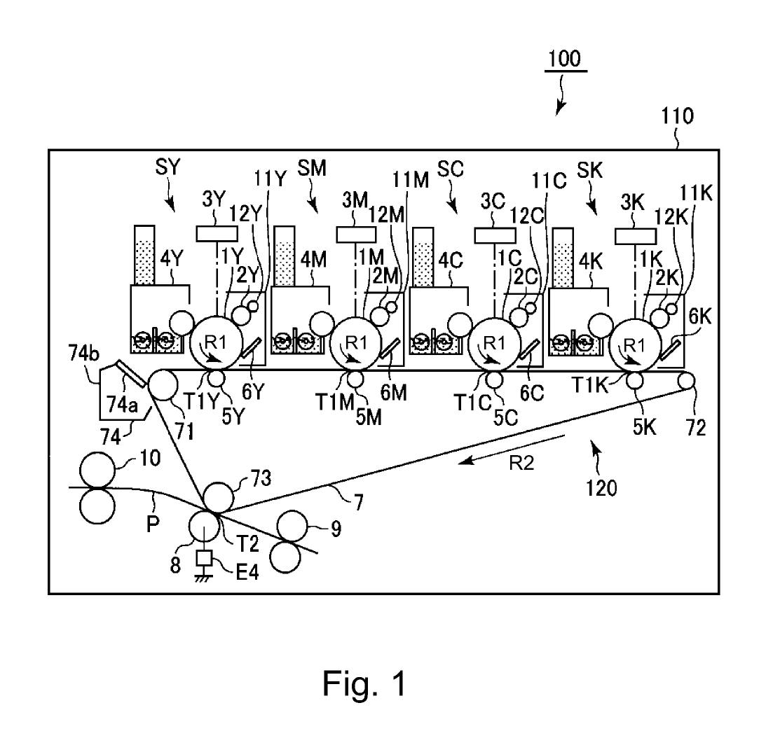

FIG. 1 is a schematic sectional view of an image forming apparatus 100 in this embodiment according to the present invention.

The image forming apparatus 100 in this embodiment is a tandem-type (in-line-type) multi-function machine which has functions of a copying machine, a printer and a facsimile machine and which employs an intermediary transfer type capable of forming a full-color image by using an electrophotographic type.

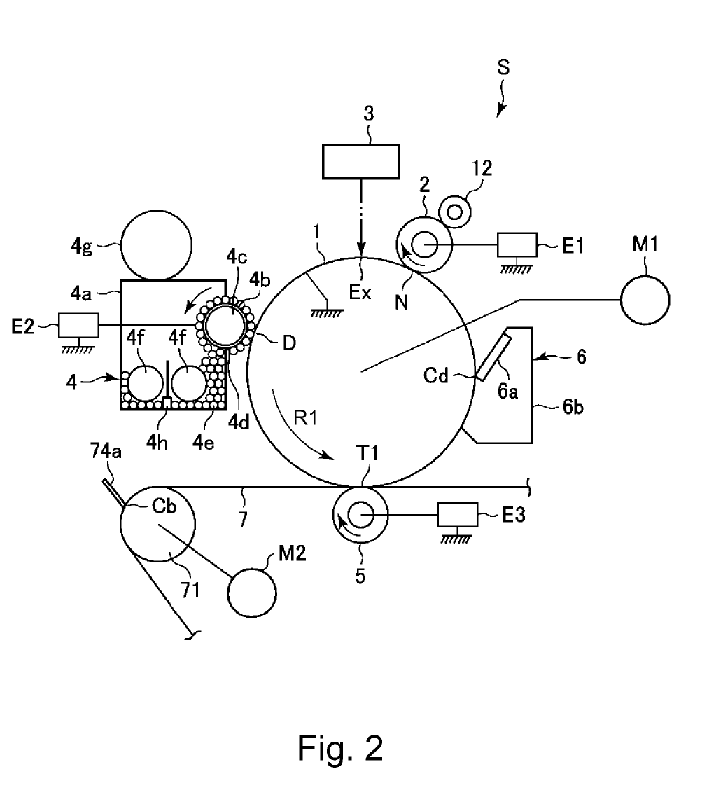

The image forming apparatus 100 includes, as a plurality of image forming portions, first to fourth image forming portions SY, SM, SC and SK for forming images of yellow (Y), magenta (M), cyan (C) and black (K), respectively. Incidentally, elements having the same or corresponding functions and constitutions in the respective image forming portions SY, SM, SC and SK are collectively described by omitting suffixes Y, M, C and K for representing elements for associated colors in some cases. FIG. 2 is a schematic sectional view showing a single image forming portion S as a representative. In this embodiment, the image forming portion S is constituted by including a photosensitive drum 1, a charging roller 2, a cleaning roller 12, an exposure device 3, a developing device 4, a primary transfer roller 5, a drum cleaning device 6, and the like, which are described later.

The image forming apparatus 100 includes the photosensitive drum 1 which is a rotatable drum-shaped (cylindrical) photosensitive member as a movable image bearing member for bearing a toner image.

The photosensitive drum 1 is rotationally driven in an indicated arrow R1 direction (counterclockwise direction) at a predetermined peripheral speed (process speed) by a drum driving motor M1 (FIG. 2) as a driving means. In this embodiment, the photosensitive drum 1 is a negatively chargeable drum-shaped organic photoconductor and is constituted by including a base layer formed of an electroconductive material such as aluminum and including a photosensitive layer (OPC layer) formed on the base layer. Further, in this embodiment, a peripheral speed of the photosensitive drum 1 is 100 mm/sec. A surface of the rotating photosensitive drum 1 is electrically charged uniformly to a predetermined polarity (negative in this embodiment) and a predetermined potential by the charging roller 2 which is a roller-type charging member as a charging means. The charging roller 2 contacts the photosensitive drum 1 and is rotated by rotation of the photosensitive drum 1. During a charging step, to the charging roller 2, a charging voltage (charging bias) which is a DC voltage (DC component) having a predetermined polarity (negative in this embodiment) is applied. Incidentally, as the charging voltage, an oscillating voltage in the form of the DC voltage biased with an AC voltage may also be used. The charged surface of the charged photosensitive drum 1 is exposed to light by the exposure device 3 as an exposure means (electrostatic image forming means), so that an electrostatic image (electrostatic latent image) is formed on the photosensitive drum 1. In this embodiment, the exposure device 3 is a laser beam scanner using a semiconductor laser.

The electrostatic image formed on the photosensitive drum 1 is developed (visualized) with the developer by the developing device 4, so that the toner image is formed on the photosensitive drum 1. The developing device 4 is an example of a supplying means for supplying toner to the image bearing member. In this embodiment, the toner charged to the same polarity as a charge polarity (negative in this embodiment) of the photosensitive drum 1 is deposited on an exposed portion of the photosensitive drum 1, where an absolute value of a potential is lowered by subjecting the surface of the photosensitive drum 1 to the exposure to the laser beam after uniformly charging the surface of the photosensitive drum 1. That is, in this embodiment, a normal toner charge polarity which is the toner charge polarity during development is the negative polarity. In this embodiment in the developing device 4, as a developer, a two-component developer containing toner (non-magnetic toner particles) and a carrier (magnetic carrier particles) is used. The developing device 4 includes a developing container 4a accommodating a developer 4e and a developing sleeve 4b which is rotatably provided to the developing container 4a so as to be partly exposed to an outside through an opening of the developing container 4a and which is formed with a non-magnetic hollow cylindrical member. Inside (at the hollow portion of) the developing sleeve 4b, a magnet roller 4e is fixedly provided to the developing container 4a. The developing container 4a is provided with a regulating blade (developer chain-cutting member) 4d is provided so as to oppose the developing sleeve 4b. Further, in the developing container 4a, two feeding screws 4f and 4f as feeding members for feeding the developer while stirring the developer are provided. Into the developing container 4a, toner is supplied appropriately from a toner hopper as a supplying means. Further, in this embodiment, a temperature sensor 4h as a temperature detecting means for detecting an environment (specifically, a temperature of the developer accommodated in the developing container 4a) in which the developing device 4 is placed is provided in the developing container 4a. In this embodiment, the temperature sensor 4h is a band gap temperature sensor (digital temperature sensor) capable of directly measuring the temperature of the developer in the developing container 4a. The developer 4e carried on the developing sleeve 4b by a magnetic force of the magnet roller 4c is fed to an opposing portion to the photosensitive drum 1 after an amount thereof is regulated by the regulating blade with rotation of the developing sleeve 4b. The developer 4e fed to the opposing portion to the photosensitive drum 1 is erected by the magnetic force of the magnet roller 4c and forms a magnetic brush (magnetic chain), and is brought into contact or proximity to the surface of the photosensitive drum 1. Further, during the development, to the developing sleeve 4b, from a developing voltage source (high-voltage source circuit) E2, as a developing voltage (developing bias), an oscillating voltage in the form of a DC voltage (DC component) biased with an AC voltage (AC component) is applied. The DC component of the developing voltage is set at a potential between a dark-portion potential (charge potential) and a light-portion potential (exposed portion potential) which are formed on the photosensitive drum 1. As a result, depending on the electrostatic latent image on the photosensitive drum 1, the toner is moved from the magnetic brush on the developing sleeve 4b onto the photosensitive drum 1, so that the toner image is formed on the photosensitive drum 1.

An intermediary transfer belt 7 constituted by an endless belt as an intermediary transfer member is provided so as to oppose the respective photosensitive drums 1. The intermediary transfer belt 7 is formed of a dielectric resin material such as polyimide in an endless shape. The intermediary transfer belt 7 is extended around a driving roller 71, a tension roller 72 and a secondary transfer opposite roller 73 which are used as stretching rollers, and is stretched with a predetermined tension. The intermediary transfer belt 7 is rotated (circulated) by rotationally driving the driving roller 71 in an indicated arrow R2 direction at a peripheral speed (process speed) substantially equal to the peripheral speed of the photosensitive drum 1 by a belt driving motor M2 (FIG. 2) as a driving means. In an inner peripheral surface side of the intermediary transfer belt 7, a primary transfer roller 5 which is a roller-type primary transfer member as a primary transfer means is provided corresponding to the associated photosensitive drum 1. The primary transfer roller 5 is pressed (urged) against the intermediary transfer belt 7 toward the photosensitive drum 1, so that a primary transfer portion (primary transfer nip) T1 where the photosensitive drum 1 and the intermediary transfer belt 7 contact each other is formed.

The toner image formed on the photosensitive drum 1 as described above is primary-transferred by the action of an electrostatic force and pressure imparted by the primary transfer roller 5 onto the intermediary transfer belt 7 at the primary transfer portion T1. During a primary transfer step, to the primary transfer roller 5, a primary transfer voltage (primary transfer bias) which is a DC voltage of an opposite polarity (positive in this embodiment) to the normal charge polarity of the toner is applied from a primary transfer voltage source (high-voltage source circuit) E3. For example, during full-color image formation, the respective color toner images of yellow, magenta, cyan and black formed on the respective photosensitive drums 1 are successively transferred superposedly onto the intermediary transfer belt 7.

At a position opposing the secondary transfer opposite roller 73 on an outer peripheral surface side of the intermediary transfer belt 7, a secondary transfer roller 8 which is a roller-type secondary transfer member as a secondary transfer means is provided. The secondary transfer roller 8 is pressed (urged) against the intermediary transfer belt 7 toward the secondary transfer opposite roller 73 and forms a secondary transfer portion (secondary transfer nip) T2 where the intermediary transfer belt 7 and the secondary transfer roller 8 are in contact with each other. The toner images formed on the intermediary transfer belt 7 as described above secondary-transferred by the action of an electrostatic force and pressure imparted by the secondary transfer roller 8 onto a transfer(-receiving) material P, such as a recording sheet, nipped and fed at the secondary transfer portion T2 by the intermediary transfer belt 7 and the secondary transfer roller 8. During a secondary transfer step, to the secondary transfer roller 8, a secondary transfer voltage (secondary transfer bias) which is a DC voltage of an opposite polarity (positive in this embodiment) to the normal charge polarity of the toner is applied from a secondary transfer voltage source (high-voltage source circuit) E4. The recording material (sheet, transfer material) P such as a recording sheet is fed one by one from a feeding device (not shown) to a registration roller pair 9, and is timed to the toner images on the intermediary transfer belt 7 by the registration roller pair 9 and then is supplied to the secondary transfer portion T2. Further, the recording material P on which the toner images are transferred is fed to a fixing device 10 and is heated and pressed by the fixing device 10, so that the toner images are fixed (melt-fixed) on the transfer material P. Thereafter, the recording material P on which the toner images are fixed is discharged (outputted) to an outside of the apparatus main assembly 110 of the image forming apparatus 100.

On the other hand, toner (primary transfer residual toner) remaining on the photosensitive drum 1 during the primary transfer is removed and collected from the surface of the photosensitive drum 1 by a drum cleaning device 6 as a photosensitive member cleaning means. The drum cleaning device 6 includes a first cleaning blade 6a (hereinafter referred also to as a first blade) as a cleaning member and includes a first cleaning container 6b. The drum cleaning device 6 rubs the surface of the rotating photosensitive drum 1 with the first cleaning blade 6a provided in contact with the photosensitive drum 1. As a result, the primary transfer residual toner on the photosensitive drum 1 is scraped off from the photosensitive drum 1 and is accommodated in the first cleaning container 6b.

Further, on an outer peripheral surface side of the intermediary transfer belt 7, a belt cleaning device 74 as an intermediary transfer member cleaning means is provided at a position opposing the driving roller 71. Toner (secondary transfer residual toner) remaining on the surface of the intermediary transfer belt 7 during a secondary transfer step is removed and collected from the surface of the intermediary transfer belt 7 by the belt cleaning device 74. The belt cleaning device 74 includes a second cleaning blade 74a (hereinafter referred also to as a second blade) as a cleaning member and includes a first cleaning container 74b. The belt cleaning device 74 rubs the surface of the rotating intermediary transfer belt 7 with the second cleaning blade 74a provided in contact with the intermediary transfer belt 7. As a result, the secondary transfer residual toner on the intermediary transfer belt 7 is scraped off from the intermediary transfer belt 7 and is accommodated in the second cleaning container 74b. The toners accommodated in the first and second cleaning containers 6b and 74b are fed by feeding members (feeding screws) (not shown) provided in the first and second cleaning containers 6b and 74b and then are collected in a residual toner container (not shown). To the charging roller 2, the cleaning roller 12 as a charging member cleaning means is contacted. The cleaning roller 12 is rotated by rotation of the charging roller 2 and cleans the surface of the charging roller 2.

In this embodiment, at each of the image forming portions S, the photosensitive drum 1, the charging roller 2, the cleaning roller 12 and the drum cleaning device 6 integrally constitute a cartridge (drum cartridge) 11 detachably mountable to the apparatus main assembly 110. Further, in this embodiment, the developing device 4 is singly detachably mountable to the apparatus main assembly 110. Incidentally, the photosensitive drum 1, the charging roller 2, the cleaning roller 12, the developing device 4 and the drum cleaning device 6 may also integrally constitute a cartridge detachably mountable to the apparatus main assembly 110.

In this embodiment, independently every image forming portion S, the photosensitive drum 1 can be normally rotated (in a rotational direction as in the image forming period), stopped and reversely rotated (in an opposite direction to the rotational direction in the normal rotation) by the drum driving motor M1, the intermediary transfer belt 7 can be rotated and stopped by the belt driving motor M2 independently of the respective photosensitive drums 1.

Here, a position, with respect to the rotational direction (surface movement direction) of the photosensitive drum 1, where the photosensitive drum 1 is charged by the charging roller 2 is a charging position. The charging roller 2 charges the photosensitive drum 1 by electric discharge generating in at least one of minute gaps formed between the charging roller 2 and the photosensitive drum 1 on sides upstream and downstream of the contact portion (charging nip) N between the charging roller 2 and the photosensitive drum 1 with respect to the rotational direction of the photosensitive drum 1. However, for simplicity, it may also be considered that the contact portion N between the charging roller 2 and the photosensitive drum 1 is deemed to be the charging position. Further, with respect to the rotational direction of the photosensitive drum 1, a position where the photosensitive drum 1 is exposed to light by the exposure device 3 is an exposure position Ex. Further, with respect to the rotational direction of the photosensitive drum 1, a position where the toner is supplied from the developing sleeve 4b to the photosensitive drum 1 (an opposing portion between the developing sleeve 4b and the photosensitive drum 1 in this embodiment) is a developing position D. Further, with respect to the rotational direction, a position where the toner image is transferred from the photosensitive drum 1 onto the intermediary transfer belt 7 (a contact portion between the photosensitive drum 1 and the intermediary transfer belt 7 in this embodiment) is a primary transfer position (primary transfer portion) T1. Further, with respect to the rotational direction of the photosensitive drum 1, a contact portion between the first blade 6a and the photosensitive drum 1 is a first cleaning position Cd. Further, with respect to the rotational direction (surface movement direction) of the intermediary transfer belt 7, a contact portion between the second blade 74a and the intermediary transfer belt 7 is a second cleaning position Cb.

Further, the image forming apparatus 100 performs a job (print operation) which is a series of operations which are started by a start instruction and in which an image is formed on a single recording material P or on a plurality of recording materials P and then the recording materials P are outputted. The job generally includes an image forming step, a pre-rotation step, a sheet interval step in the case where the image is formed on the plurality of the recording materials P, and a post-rotation step. The image forming step is a period in which formation of the electrostatic image for an image formed and outputted on the recording material P, formation of the toner image, and primary transfer and secondary transfer of the toner image are actually performed, and the “image forming period (during image formation)” refers to this period. Specifically, at each of positions where steps of effecting the formation of the electrostatic image, the formation of the toner image, and the primary transfer and the secondary transfer of the toner image, timing in the image forming period is different. The pre-rotation step is a period in which a preparatory operation, from input of the start instruction until the image formation is actually started, before the image forming step is performed. The sheet interval step is a period corresponding to an interval between a recording material P and a subsequent recording material P when the image formation is continuously performed (continuous image formation) with respect to the plurality of recording materials P. The post-rotation step is a period in which a post-operation (preparatory operation) after the image forming step is performed. “Non-image forming period (during non-image formation)” refers to a period other than the “image forming period”, and includes the pre-rotation step, the sheet interval step, the post-rotation step and further includes a pre-multi-rotation step which is a preparatory operation during main switch actuation of the image forming apparatus 100 or during restoration from a sleep state.

### 2. Reversely Rotating Operation

The image forming apparatus 100 in this embodiment is capable of executing a reversely rotating operation (first operation) in which in order to remove a foreign matter such as paper powder sandwiched between the photosensitive drum 1 and the first blade 6a, the photosensitive drum 1 is reversely rotated when the photosensitive drum is stopped after an end of the image formation. In this embodiment, the reversely rotating operation is executed every time, except for a predetermined case described later, when the photosensitive drum 1 is stopped after the end of the image formation. That is, in this embodiment, the reversely rotating operation is performed at the time of an end of every job except for the predetermined case described later.

Here, the paper powder includes an arbitrary substance, derived from principally a component of the recording material P, which is deposited on the recording material P by being generated from the recording material P during processing such as cutting of the recording material P and which is deposited on the recording material P by being generated from the recording material P due to sliding of the recording material P an another member in the image forming apparatus 100. Typically, the paper powder is constituted by fibers containing cellulose as a main component and by a filler such as powder of calcium carbonate.

A reverse rotation amount (distance) of the photosensitive drum 1 in the reversely rotating operation may preferably be a width (about 10 μm in this embodiment), with respect to the rotational direction (circumferential direction) of the photosensitive drum 1, in which the photosensitive drum 1 and the first blade 6a are in contact with each other. When the reverse rotation amount is smaller than this width, in some cases, an effect of removing the foreign matter such as the paper powder from between the photosensitive drum 1 and the first blade 6a lowers. On the other hand, the reverse rotation amount may preferably be shorter than a distance between the charging nip N and the developing position D with respect to the rotational direction (circumferential direction) of the photosensitive drum 1. When the reverse rotation amount is more than this distance, in some cases, the toner deposited on the photosensitive drum 1 at the developing position D is deposited on the charging roller 2 and thus the charging roller 2 is contaminated with the toner. In this embodiment, the reverse rotation amount is 8 mm, with respect to the rotational direction of the photosensitive drum 1, which is not less than the width of the contact between the photosensitive drum 1 and the first blade 6a and which is shorter than the distance between the charging nip N and the developing position D. Further, in this embodiment, after the photosensitive drum 1 is reversely rotated by a predetermined amount, the photosensitive drum 1 is stopped without being normally rotated again.

In this embodiment, the image forming apparatus 100 includes a spacing mechanism (not shown) as a spacing means for spacing the intermediary transfer belt 7 from the photosensitive drum 1 by spacing the primary transfer roller 5 of each image forming portion S from the photosensitive drum 1. In this embodiment, normal rotation of the intermediary transfer belt 7 is stopped in synchronism with a stop of normal rotation of the photosensitive drums 1, and therefore, the intermediary transfer belt 7 is spaced from all the photosensitive drums 1 before reverse rotation of any one of the photosensitive drums 1 is started. Further, in this embodiment, also in the case where all the photosensitive drums 1 are not reversely rotated, the normal rotation of the intermediary transfer belt 7 is stopped in synchronism with the stop of the normal rotation of the photosensitive drums 1, and thereafter, the intermediary transfer belt 7 is spaced from all the photosensitive drums 1.

### 3. Image Processing

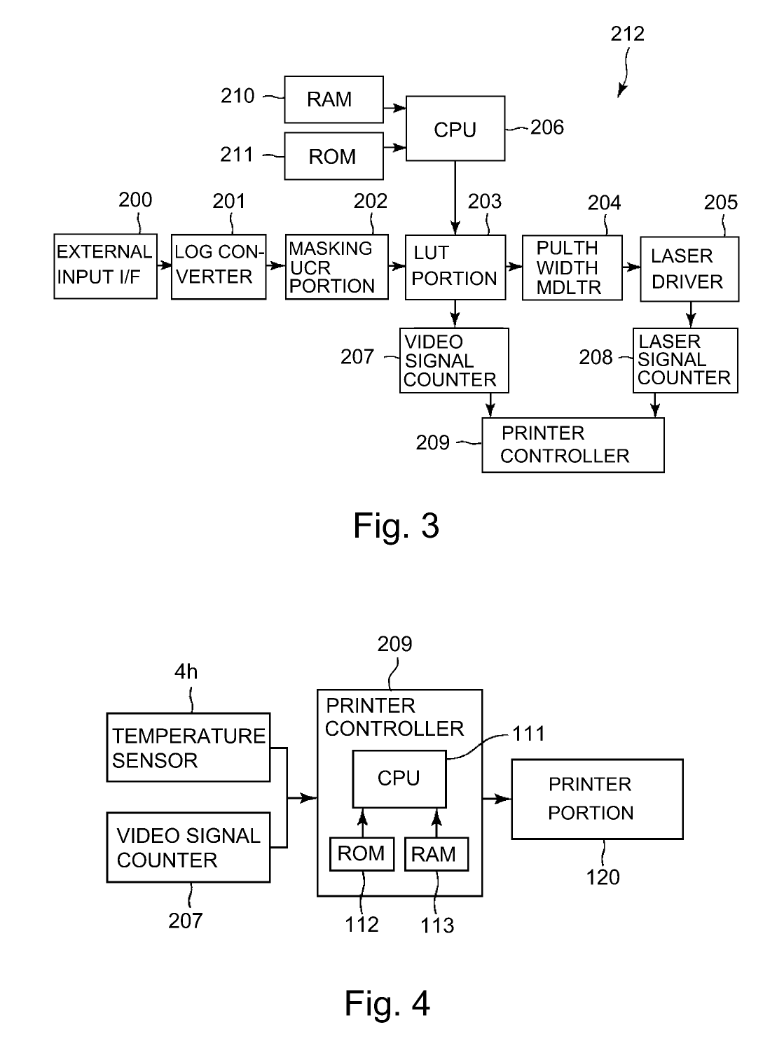

FIG. 3 is a block diagram showing a system constitution of an image processing unit 212 in the image forming apparatus 100 in this embodiment. In FIG. 3, through an external input interface (I/F) 200, color image data as RGB image data are inputted from an unshown external device such as an original scanner or a computer (information processing device) to a LOG conversion portion 201 via an external input interface (external input I/F) 200 as desired. The LOG conversion portion 201 converts luminance data of the input RGB image data into CMY density data (CMY image data) on the basis of a look-up table constituted (prepared) by data or the like stored in an ROM 210. A masking UCR portion 202 extracts a black (K) component data from the CMY image data and subjects CMYK image data to matrix operation in order to correct color shading of a recording colorant. A look-up table portion (LUT portion) 203 makes density correction of the input CMYK image data every color by using a gamma (γ) look-up table in order that the image data are caused to coincide with an ideal gradation characteristic of a printer portion 120. Here, the printer portion 120 refer to a unit, constituted by the above-described respective image forming portions S, the intermediary transfer belt 7, the secondary transfer roller 8, the fixing device 10 and the like, for forming and outputting the image on the recording material P. Incidentally, the γ look-up table is prepared on the basis of the data developed on an RAM 211 and the contents of the table are set by a CPU 206.

A pulse width modulation portion 204 outputs a pulse signal with a pulse width corresponding to image data (image signal) inputted from the LUT portion 203. On the basis of this pulse signal, a laser driver 205 drives a laser emitting element, so that the surface of the photosensitive drum 101 is irradiated with laser light by the exposure device 5 and thus the electrostatic latent image is formed on the photosensitive drum 101. A video signal counting portion 207 adds up a level for each pixel (0 to 255 level) for a screenful of the image with respect to 600 dpi of the image data input into the LUT portion 203. The integrated value of the image data is referred to as a “video count value”. A maximum of this video count value is 1023 in the case where all the pixels for the outputted image are at the 255 level. Incidentally, when there is a restriction on the constitution of the circuit, by using a laser signal count portion 208 in place of the video signal counting portion 207, the image signal from the laser drive 205 is similarly calculated, so that it is possible to obtain the video count value.

### 4. Discharging Operation

### 4-1. Outline of Discharging Operation

In order to increase a proportion of fresh toner in the developing device 4, the image forming apparatus 100 in this embodiment is capable of executing a discharging operation in which the toner is discharged (forcedly consumed) from the developing device 4 to a non-image region of the photosensitive drum 1. In this embodiment, the toner discharged from the photosensitive drum 1 to the photosensitive drum 1 by the discharging operation (hereinafter, this toner is referred also to as a “discharged toner” is collected by the drum cleaning device 6. The discharging operation is an example of a supplying operation (second operation) in which the toner supplied to the image bearing member is supplied to the contact portion between the image bearing member and the cleaning member by a supplying means.

In the case where formation of an image with a low image ratio is continued, a proportion of the toner moved from the inside of the developing device 4 to the photosensitive drum 1 is small, so that an amount of the toner supplied to the developing device 4 is small. For that reason, the toner in the developing device 4 is subjected to stirring by the feeding screws 4f and 4f and friction during passing thereof through the regulating blade 4d, for a long time. As a result, the external additive of the toner is liberated from a toner base material or is buried into the toner base material, so that flowability and a charging performance of the toner become worse and thus an image quality deteriorates in some cases. Incidentally, a print ratio refers to a proportion of a toner deposition area to an area of a maximum image formable region (in which the toner image is formable), and is 100% in the case of a solid image and is 0% in the case of no image (solid white image).

Therefore, in this embodiment, the image forming apparatus 100 executes the discharging operation in which the deteriorated toner is discharged (forcedly consumed) onto the photosensitive drum 1. Here, a degree of progression of the toner deterioration varies depending on the print ratio (i.e., the proportion of the deteriorated toner increases with a lower print ratio). Further, the degree of progression of the toner deterioration varies depending on also an environment in which the image forming apparatus 100 is placed (specifically, in an environment in which the developing device 4 is placed, more specifically, a temperature of the developer). For that reason, it is desired that depending on the print ratio or the environment in which the developing device 4 is placed, an amount of the toner discharged by the discharging operation is changed by changing a time in which the toner is discharged from the developing device 4 or a frequency of execution of the discharging operation.

In this embodiment, the frequency of execution of the discharging operation is changed depending on the print ratio or the environment in which the developing device 4 is placed (specifically, the temperature of the developer), so that the amount of the toner per unit time discharged from the developing device 4 is changed. Specific control of the discharging operation will be described later.

### 4-2. Temperature Dependence of Toner Deterioration

As described above, the toner deterioration progresses in the case where formation of the image with the low print ratio is continued and the proportion of the toner moved from the developing device 4 to the photosensitive drum 1 is small and thus the amount of the toner supplied to the developing device 4 is small (i.e., in the case where the print ratio is low). A speed of the progression of the toner deterioration varies depending on the environment in which the developing device 4 is placed (specifically, an ambient temperature of the developer).

Here, the following experiment for evaluating the degree of the progression of the toner deterioration was conducted. In a plurality of different temperature environments, the developing devices 4 for the respective colors of yellow (Y), magenta (M), cyan (C) and black (K) were placed. In each of the temperature environments, the print ratio for each of the colors was changed (print ratio: 0% to 5%), and continuous image formation of 10,000 sheets (A4 size, one-side image formation) was carried out, and then a change in image quality was checked before and after the continuous image formation was carried out. Here, an operation of the continuous image formation refers to a series of image forming operations for continuously forming images on a plurality of recording materials P. As a representative example, a result for the black (i.e., temperature dependence of deterioration of black toner) is shown in Table 1.

TABLE 1

| | |
|---|---|
| | Developing |
| | device |
| Print | temperature |
| ratio | (° C.) |

| (%) | 20 | 30 | 40 | 50 |
|---|---|---|---|---|
| 0 | x | x | x | x |
| 1 | x | x | x | x |
| 2 | ∘ | x | x | x |
| 3 | ∘ | ∘ | x | x |
| 4 | ∘ | ∘ | ∘ | x |
| 5 | ∘ | ∘ | ∘ | ∘ |

In Table 1, the developing device temperature is a detection result of the temperature sensor 4h mounted in the developing device 4. Further, “o” represents that no image quality deterioration occurred, and “x” represents that image quality deterioration of at least one of worsening of fog (phenomenon that the toner is deposited on the non-image portion), worsening of toner scattering, and worsening of graininess occurred.

From the result of Table 1, the following is understood. That is, in the case where the temperature is low (for example, 20° C.), the degree of the progression of the toner deterioration is slow, so that the image quality deterioration does not occur even when the print ratio is low to some extent (even when the print ratio of 2% at 20° C.). On the other hand, in the case where the temperature is high (for example, 50° C.), the degree of the progression of the toner deterioration is fast, so that the image quality deterioration occurs unless the print ratio is high (5% or more at 50° C.). In other words, in the image forming apparatus 100 of this embodiment, when formation of the image with a print ratio (i.e., a video count) of not less than a certain value is not carried out, in some instances, a lowering in image quality, such as worsening of fog, worsening of toner scattering or worsening of graininess, due to the toner deterioration occurs. Further, the print ratio (i.e., the video count) which is a threshold at which the lowering in image quality occurs varies depending on the temperature of the photosensitive drum 4.

Therefore, in this embodiment, in order to prevent the lowering in image quality due to the toner deterioration from occurring, the video count corresponding to a minimum necessary toner consumption amount is defined as a “toner deterioration threshold video count Vt”. The toner deterioration threshold video count Vt is a value depending on the temperature of the developer and a value which can be acquired by the above-described experiment or the like.

Table 2 below shows print ratios, for the respective colors, which are thresholds at which the image quality lowering at the respective temperatures occurs. Further, Table 3 below shows toner deterioration threshold video counts Vt set on the basis of relationships of Table 2 at respective temperature ranges for the respective colors in the image forming apparatus 100 of this embodiment. Incidentally, the toner deterioration threshold video count Vt varies depending on the colors and materials of the developers (toners and carriers), the structure of the developing devices 4, and the like, and thus may be appropriately set.

TABLE 2

| | |
|---|---|
| | Print ratio |
| | (%) of toner |
| | deterioration |
| Temperature | threshold |

| (° C.) | Y | M | C | K |
|---|---|---|---|---|
| -25 | 2 | 2 | 2 | 2 |
| 25-35 | 3 | 3 | 3 | 3 |
| 35-45 | 4 | 4 | 4 | 4 |
| 45- | 5 | 5 | 5 | 5 |

TABLE 3

| | |
|---|---|
| | Discharging |
| | threshold |
| | (image duty) |
| Temperature | (%) |

| (° C.) | Y | M | C | K |
|---|---|---|---|---|
| -25 | 10 | 10 | 10 | 10 |
| 25-35 | 15 | 15 | 15 | 15 |
| 35-45 | 20 | 20 | 20 | 20 |
| 45- | 26 | 26 | 26 | 26 |

### 4-3. Control of Discharging Operation

Next, control of the discharging operation will be described.

FIG. 4 is a block diagram of a principal portion of a printer controller 209 (FIG. 3) in this embodiment. The printer controller 209 effects integrated control of operations of respective portions of the printer portion 120 of the image forming apparatus 100. The printer controller 209 is constituted by including a CPU 111 as a control means (controller) and a ROM 112 and a RAM 113 which are used as storing means (storing portions). In accordance with a program stored in the ROM 112, the CPU 111 controls the operations of the respective portions of the printer portion 120 while using the RAM 113 as a working area (workspace). Particularly, in this embodiment, the CPU 111 not only carries out control of the discharging operation described in this section and control of a lubricity imparting operation described later but also carries out reversely rotating operation properness control described later.

To the CPU 111, information indicating a detection result of the temperature of the developer by the temperature sensor 4h (FIG. 2) and information indicating a result of the video count by the video signal counting portion 207 (FIG. 3) are sent. Then, on the basis of these pieces of the information, the CPU 111 discriminates timing of execution of the discharging operation and provides an instruction to the respective portions of the printer portion 120 when the timing arrives, and thus causes the associated portions to execute the discharging operation.

Incidentally, as described above, the temperature sensor 4h is the band gap temperature sensor capable of directly measuring the temperature of the developer in the developing container 4a. As the temperature detecting means, it is also possible to use an environment sensor (environment detecting means) for detecting a temperature in at least one of an inside and an outside of the apparatus main assembly 110 of the image forming apparatus 100. However, from a viewpoint that productivity and the image quality are compatibly realized by properly controlling execution timing of the discharging operation by enhancing accuracy of the toner deterioration threshold video count Vt, the temperature detecting means for directly detecting the temperature of the developer in the developing container 4a as in this embodiment may preferably be used.

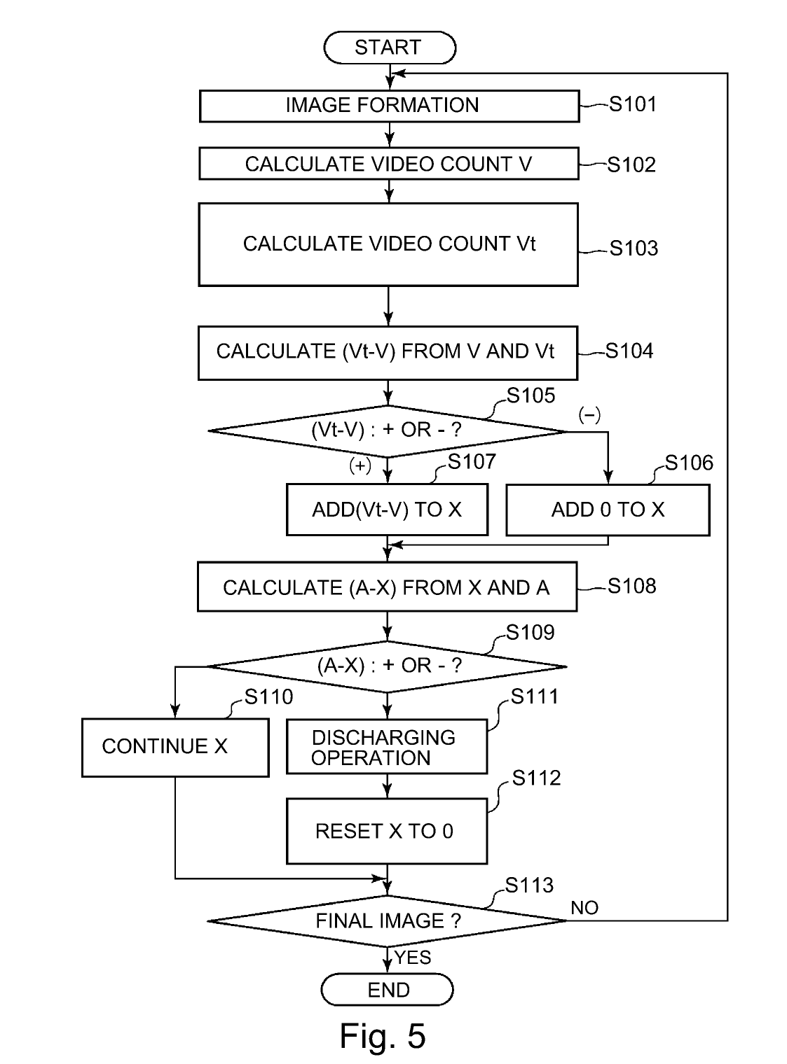

FIG. 5 is a flowchart showing an outline of a procedure of the control of the discharging operation in this embodiment. The control of this procedure is executed by the CPU 111 of the printer controller 209. In this embodiment, as an easy-to-understand example, the case where an image with print ratios per (one) sheet of the respective colors which are Y=5%, M=5%, C=5% and K=3% (hereinafter, this image is referred to as a “low-duty-black image chart” will be considered.

When the image formation is started (S101), the CPU 111 reaches video counts V(K), V(M), V(C) and V(K) for the respective colors counted by the video signal count portion 207 and reads temperatures detected by the temperature sensors 4h fort the respective colors (S102). In this embodiment, the video count of the whole (entire) surface solid image (print ratio: 100%) on one surface (side) of A4-sized sheet for a one color is 512. Accordingly, the video counts of the “low-duty-black image chart” are V(Y)=26, V(M)=26, V(C)=26 and V(K)=15. Incidentally, when each video count is calculated, the fractional portion of the number is rounded off to the nearest integer.

Next, on the basis of a detection result of the temperature sensor 4h and information (FIG. 3) showing a relationship between a preset developer temperature and the toner deterioration threshold video count Vt, for each of the colors, the CPU 111 acquires the toner deterioration threshold video count Vt at a current temperature (S103).

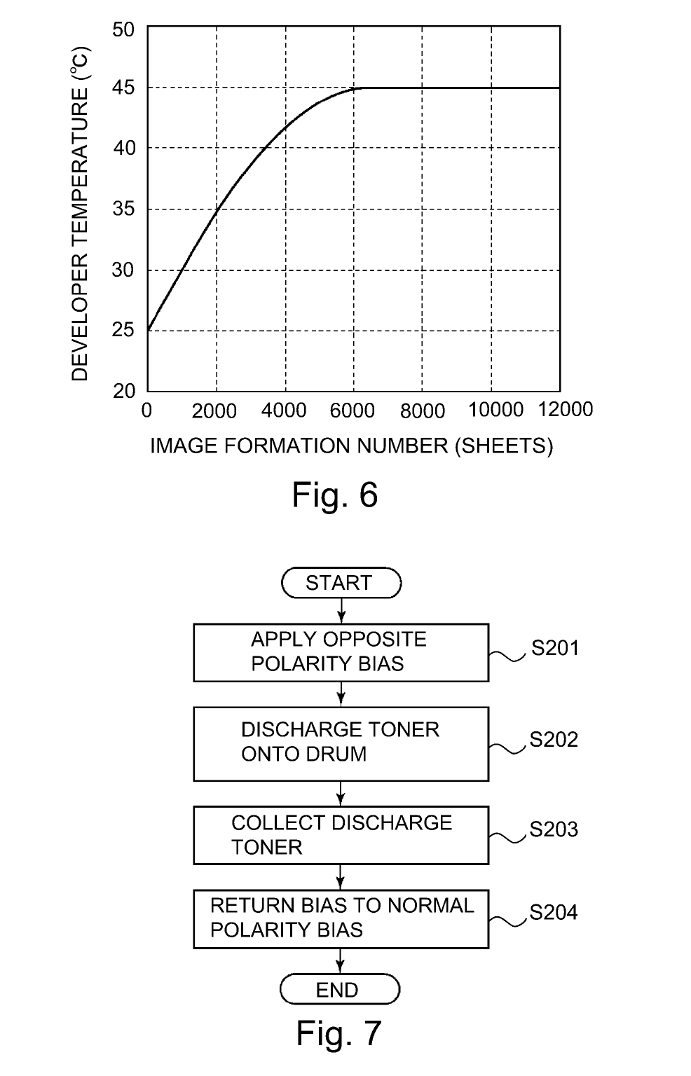

Here, FIG. 6 shows progression of a detection result of the temperature sensor 4h for black in the case where the “low-duty-black image chart” is continuously formed on A4-size sheets. In this case, the image forming apparatus 100 was placed in a fixed environment of a temperature of 23° C. and a relative humidity of 50% RH. In FIG. 6, the abscissa represents a continuous image formation number, and the ordinate represents the detection result of the temperature sensor 4h. As is understood from FIG. 6, even when the placement environment of the image forming apparatus 100 is maintained at a certain environment (temperature: 23° C., relative humidity: 50% RH), the detection result (i.e., the developer temperature) gradually increases (but is saturated at about 45° C.). This temperature rise would be considered due to a self-temperature rise by rotation of the developing sleeve 4b and the feeding screws 4f and 4f in the developing device 4 and a self-temperature rise of motors or the like in the image forming apparatus 100. Accordingly, depending on the continuous image formation number, the toner deterioration threshold video count Vt for determining execution timing of the discharging operation changes.

Referring again to the flowchart of FIG. 5, the CPU 111 calculates a difference (=Vt−V) between the video count and the toner deterioration threshold video count Vt for each color (S104). Then, the CPU 111 discriminates whether the value “Vt−V” is positive or negative for each color (S105). Then, in the case where the CPU 111 discriminated that the value “Vt−V” is negative for each color in S105, the CPU 111 adds 0 to a toner deterioration integration value X and stores a resultant value in the RAM 113 (S106). This is because in this state, the print ratio is high and thus the toner deterioration does not readily progresses. On the other hand, in the case where the CPU 111 discriminated that the value “Vt−V” is positive for each color in S105, the CPU 111 adds “Vt-V” to the toner deterioration integration value X and stores a resultant value in the RAM 113 (S107). This is because in this state, the print ratio is low and thus the toner deterioration is liable to progress. Here, the toner deterioration integration value X refers to an index indicating a current toner deterioration state and is an integrated value of video count values calculated by “Vt-V”.

Next, for each color, the CPU 111 calculates a difference (=A-X) between a discharge execution threshold A and the toner deterioration integration value X calculated and renewed every image formation of a single sheet (S108). Here, the discharge execution threshold A is a predetermined value which can be arbitrarily set. With a smaller discharge execution threshold A, a frequency of execution of the discharging operation becomes larger even in continuous formation of the image with the same print ratio. In this embodiment, the discharge execution threshold A is set at 512 for all the colors. When the set value of the discharge execution threshold A is excessively large, a time in which the toner deterioration progresses until the toner discharging operation is performed is long, so that it is desirable that the set value is approximately equal to the video count value of the whole surface solid image (the image with the print ratio of 100%) on one surface of A4-size sheet to A3-size sheet. Further, e.g., with a larger volume of the developer which can be retained in the developing container 4a, there is a tendency that the toner discharge execution threshold A can be set at a larger value. Incidentally, the discharge execution threshold A may be the same for all the colors or may also be different between a plurality of the colors (i.e., different for each of the colors).

Then, the CPU 111 discriminates whether the value “A-X” is positive or negative for each color (S109). In the case where the CPU 111 discriminated that the value “A-X” is positive for all the colors in S109, the CPU 111 determines that the image formation is continued and causes the process to go to S113 (S110). This is because for all the colors, the toner deterioration does not progress to the extent that the discharging operation should be executed at this time. On the other hand, the CPU 111 discriminated that there is a color for which the value “A-X” is negative in S109, the CPU 111 causes the developing device 4 to executes the discharging operation for the associated color. This is because for the associated color, the toner deterioration progresses to the extent that the discharging operation should be executed at this time. Then, for the associated color, the CPU 111 resets the toner deterioration integration value X to 0 after the discharging operation is executed (but does not reset the toner deterioration integration value X to 0 for the colors for which the discharging operation is executed), and causes the process to go to S113 (S112). In this manner, as regards the color requiring the discharging operation, the discharging operation is carried out in the sheet interval step in the case where the image formation of the job is during execution, and is carried out in the post-rotation step in the case where the image formation of the job is ended.

The CPU 111 discriminates whether or not formation of all the images designated in the job is ended (S113), and in the case where the CPU 111 discriminated that the image formation is not ended, the CPU 111 returns the process to S101, and in the case where the CPU 111 discriminated that the image formation is ended, the CPU 111 ends the job. At this time, in this embodiment, all the photosensitive drums 1 are subjected to the reversely rotating operation after the stop of the normal rotation except for a predetermined case described later.

FIG. 7 is a flowchart specifically showing a procedure of the discharging operation in this embodiment. This procedure corresponds to the process of S111 in the procedure of FIG. 5.

In the case where the CPU 111 discriminated in the process of S109 in FIG. 5 that there is a color for which the value “A−X” is negative, the CPU 111 interrupts the image formation and then causes the developing device 4 to execute the discharging operation for the associated color. First, the CPU 111 causes the primary transfer voltage source to apply the voltage of an opposite polarity (negative in this embodiment) to the polarity of the voltage during a normal image forming period, i.e., the voltage of the same polarity as the normal charge polarity of the toner, to the primary transfer roller 5 for the associated color (S201). This is because the discharged toner is electrostatically repelled from the intermediary transfer belt 7 at the primary transfer portion T1 and is collected by the drum cleaning device 6 without being transferred onto the intermediary transfer belt 7. Then, for the associated color, the CPU 111 causes the image forming portion to form, on the photosensitive drum 1, the toner image in a toner amount corresponding to the video count equivalent to the discharge execution threshold A, so that the toner is discharged from the developing device 4 (S202). Thereafter, the CPU 111 is on stand-by until the discharged toner is collected by the drum cleaning device 6 (S203). Then, the CPU 111 returns the polarity of the voltage applied to the primary transfer roller 5 for the associated color, to the polarity of the voltage in the normal image forming period (S204), and then causes the developing device 4 to end the discharging operation. Thereafter, the CPU 111 causes the process to go to the process of S112 in FIG. 5.

Incidentally, the discharging operation may preferably be controlled so that the developing sleeve 41 is rotated through at least one-full circumference during the discharging operation. This is because the deteriorated toner on the developing sleeve 4b is sufficiently discharged or the like. Further, in this embodiment, the toner image formed on the photosensitive drum 1 in the discharging operation is formed similarly as in the normal image forming period by being subjected to the charging step, the exposure step and the developing step of the photosensitive drum 1. This toner image may preferably be formed at a relatively high density level in a substantially entire area of the image formable region on the photosensitive drum 1 with respect to a rotational axis direction of the photosensitive drum 1 for the purpose of suppressing a downtime (a time in which the image cannot be outputted) to the minimum or the like purpose. In this embodiment, this toner image is a solid image extending over the substantially entire area of the image formable region on the photosensitive drum 1 with respect to the rotational axis direction of the photosensitive drum 1.

In the discharging operation, the toner in a sufficient amount may only be required to be discharged from the developing device 4. For example, an image forming process condition is changed and fog is positively generated on the photosensitive drum 1, so that the toner can also be discharged from the developing device 4. That is, at least one of the charging voltage and the developing voltage is changed from the setting in the normal image forming period, so that an electric field for urging the toner from the photosensitive drum 1 toward the developing sleeve 4b is weakened or an electric field for urging the toner from the developing sleeve 4b toward the photosensitive drum 1 is generated. Such a state can be formed by making a potential difference between the dark portion potential of the photosensitive drum 1 and the DC component of the developing voltage smaller than that in the image forming period or by applying the developing voltage without charging the photosensitive drum 1. For example, the charging voltage is turned off when a predetermined region of the photosensitive drum 1 with respect to the rotational direction of the photosensitive drum 1 passes through the charging position, and then the developing voltage is turned on when the predetermined region passes through the developing position, so that the toner can be discharged from the developing device 4.

Table 4 below shows the following values in the case where the “low-duty-black image chart” is formed. That is, the values include, for each color, the print ratio per (one) sheet, the video count per sheet, a range of the toner deterioration threshold video count Vt selected depending on the developer temperature, a range of the calculated (Vt-V), and a range of the toner deterioration integration value X integrated per sheet.

TABLE 4

| | Color | | | |
|---|---|---|---|---|
| Values | Y | M | C | K |
| Print ratio (%) | 5 | 5 | 5 | 3 |
| Video Counter: V | 26 | 26 | 26 | 15 |
| TDTVC*¹: Vt | 10 to 26 | 10 to 26 | 10 to 26 | 15 to 26 |
| Vt − V | −16 to 0 | −16 to 0 | −16 to 0 | 0 to 11 |
| TDIV*²: X | 0 | 0 | 0 | 0 to 11 |

*¹“TDTVC” is the toner deterioration threshold video count.
*²“TDIV” is the toner deterioration integration value per sheet.

As described above, in this embodiment, the discharging operation is carried out at predetermined timing depending on information on the toner amount of the image formed on the photosensitive drum 1 in the image forming period. In this embodiment, the CPU 111 controls an execution frequency of the discharging operation so as to be higher in the case where the video count (or the print ratio) as information on the toner amount is a second value, smaller than a first value, than in the case where the video count is the first value. That is, the CPU 111 carries out the control so that at the same developer temperature, the amount per unit image formation of the toner discharged by the discharging operation satisfies the following relationship. That is, the CPU 111 carries out the control so that the amount per unit image formation of the toner discharged by the discharging operation is larger in the case where the video count (or the print ratio) is the second value, smaller than the first value, than in the case where the video count is the first value.

Further, in this embodiment, the discharging operation is executed at the predetermined timing depending on information on the temperature. In this embodiment, the information on the temperature is information on a toner temperature. In this embodiment, on the basis of the detection result of the temperature sensor 4h, the CPU 111 controls the execution frequency of the discharging operation so as to be higher in the case where the temperature in the developing device 4 is a second temperature, higher than a first temperature, than in the case where the temperature in the developing device 4 is the first temperature. That is, in the case where the images with the same print ratio are continuously formed, the CPU 111 carries out control so as to satisfy the following relationship. That is, the CPU 111 carries out the control so that the amount per unit image formation of the toner discharged by the discharging operation is larger in the case where the temperature in the developing device 4 is the second temperature, higher than the first temperature, than in the case where the temperature in the developing device 4 is the first temperature.

In this embodiment, in the case where the “low-duty-black image charts” are continuously formed on 10,000 A4-size sheets, the image formation is interrupted about 115 times, and then the discharging operation is executed about 115 times. Further, by a single discharging operation, the toner in the amount corresponding to a video count of 512 is consumed. On the other hand, in the case where the change in toner deterioration threshold depending on the temperature is not taken into consideration, for example, the toner deterioration integration value X per sheet during the continuous image formation of 10,000 sheets is always +11, so that the discharging operation is executed about 214 times. That is, according to this embodiment, an increase in toner consumption amount can be suppressed.

### 5. Lubricity Imparting Operation

In order to suppress the inconveniences such as the turning-up of the cleaning blade, the image forming apparatus 100 of this embodiment is capable of executing a lubricity imparting operation for supplying the toner from the developing device 4 onto the photosensitive drum 1 in a non-image region. In this embodiment, the toner supplied from the developing device 4 to the photosensitive drum 1 by the lubricity imparting operation (hereinafter, this toner is also referred to as a “lubricity imparting toner”) is supplied to the first cleaning position Cd, so that a lubricant (external additive of the toner) is supplied to between the photosensitive drum 1 and the first blade 6a. The lubricity imparting operation is an example of the supplying operation (second operation) for supplying the toner, supplied to the image bearing member by the supplying means, supplied to the contact portion between the image bearing member and the cleaning member.

In this embodiment, the CPU 111 of the printer controller 209 causes the developing device 4 to execute the lubricity imparting operation so that the lubricity imparting toner in a predetermined amount is supplied to the first cleaning position Cd at predetermined timing.

The lubricity imparting toner can be supplied to the photosensitive drum 1 by forming a predetermined toner image through the charging step, the exposure step and the developing step of the photosensitive drum 1 similarly as in the normal image forming period. This toner image can be formed in a line shape or a band shape extending in the rotational axis direction of the photosensitive drum 1, i.e., along a longitudinal direction of the contact portion between the photosensitive drum 1 and the cleaning blade 6a. Typically, this toner image is formed in the line shape or the band shape extending over a substantially entire area of the image formable region on the photosensitive drum 1 with respect to the rotational axis direction of the photosensitive drum 1. However, the toner image may also be a single or plurality of toner images formed in an arbitrary length with respect to a direction crossing a surface movement direction of the photosensitive drum 1. For example, the toner image may also be a toner image formed along the direction crossing the surface movement direction of the photosensitive drum 1 so as to correspond to a portion of the first blade 6a where the turning-up of the first blade 6a is liable to occur. In this embodiment, the toner image was a band-shaped toner image of 1 mm in width with respect to the rotational direction of the photosensitive drum 1 (i.e., recording material feeding direction) and 305 mm (i.e., an entire area of the image formable region) in length with respect to the rotational axis direction of the photosensitive drum 1.

Further, timing of execution of the lubricity imparting operation can be appropriately set so that the lubricant can be supplied to between the photosensitive drum 1 and the first blade 6a before a frictional force between the photosensitive drum 1 and the first blade 6a increases to the extent that the inconveniences such as the turning-up occur. For example, the lubricity imparting operation can be executed at predetermined timing depending on an index value correlating with the number of formed images. As the index value, it is possible to cite the image formation number, and a travelling potential, a rotation number and a rotation time of the photosensitive drum 1, and the like. Further, the lubricity imparting operation can also be executed at predetermined timing depending on information on the amount of the toner formed on the photosensitive drum 1 in the image forming period. As the information, it is possible to cite a print ratio of the image formed in a predetermined image formation number, and the like. In this embodiment, in the case where the lubricity imparting operation is executed in the sheet interval step during the continuous image formation, the lubricity imparting operation is executed in the sheet interval step after continuous image formation of 100 sheets (A4-size conversion). Further, in the case where the lubricity imparting operation is executed in the post-rotation step the lubricity imparting operation is executed in the post-rotation step after an integrated image formation number from the last lubricity imparting operation reaches 70 sheets (A4-size conversion). In this embodiment, the lubricity imparting operation is executed in synchronism with all the image forming portions. However, whether or not the lubricity imparting operation should be executed may also be discriminated for each of the colors.

In the lubricity imparting operation, the lubricity imparting toner in a sufficient amount can only be required to be supplied to the first cleaning position Cd. For example, the fog is positively generated on the photosensitive drum 1 by changing the image forming process condition, and the toner caused the fog can also be used as the lubricity imparting toner. That is, at least one of the charging voltage and the developing voltage is changed from the setting in the normal image forming period, so that an electric field for urging the toner from the photosensitive drum 1 toward the developing sleeve 4b is weakened or an electric field for urging the toner from the developing sleeve 4b toward the photosensitive drum 1 is generated. Such a state can be formed by making a potential difference between the dark portion potential of the photosensitive drum 1 and the DC component of the developing voltage smaller than that in the image forming period or by applying the developing voltage without charging the photosensitive drum 1. For example, the charging voltage is turned off when a predetermined region of the photosensitive drum 1 with respect to the rotational direction of the photosensitive drum 1 passes through the charging position, and then the developing voltage is turned on when the predetermined region passes through the developing position, so that the toner can be supplied to the photosensitive drum 1.

Further, an amount of the lubricity imparting toner can be changed depending on an environment (specifically, an ambient temperature of the first blade 6a) in which the image forming apparatus 100 is placed. For that reason, as the temperature detecting means, an environment sensor for detecting a temperature of at least one of an inside and an outside of the apparatus main assembly 110 of the image forming apparatus 100 can be used or a temperature sensor for detecting an ambient temperature of the first blade 6a can be provided. Typically, control is carried out so that the amount of the lubricity imparting toner is larger in the case where the temperature detected by the temperature detecting means is a second temperature, higher than a first temperature, than in the case where the temperature detected by the temperature detecting means is the first temperature. This is because the inconveniences such as the turning-up of the first blade 6a are more liable to occur at a relatively high temperature than at a relatively low temperature. Incidentally, an execution frequency of the lubricity imparting operation may also be changed depending on the environment in which the image forming apparatus 100 is placed (specifically, depending on the ambient temperature of the first blade 6a). In this case, control is carried out so that the execution frequency of the lubricity imparting operation is higher at the second temperature, higher than the first temperature, than at the first temperature, and thus control is carried out so that the amount per unit image formation of the toner supplied to the first cleaning position Cd increases.

In the case where the lubricity imparting operation is executed in the post-rotation step, a surface movement distance of the photosensitive drum 1 from arrival of the lubricity imparting toner at the first cleaning position Cd until the rotation of the photosensitive drum 1 stops may preferably be set in the following manner. That is, it is preferred that the surface of the photosensitive drum 1 after the lubricity imparting toner reaches the first cleaning position Cd moves in a distance of 10 mm or more. As a result, the lubricant can be satisfactorily supplied to between the photosensitive drum 1 and the first blade 6a. In this embodiment, the surface movement distance of the photosensitive drum 1 from the arrival of the lubricity imparting toner at the first cleaning position Cd until the rotation of the photosensitive drum 1 stops was set at 10 mm. Incidentally, the surface movement distance of the photosensitive drum 1 from the arrival of the lubricity imparting toner at the first cleaning position Cd until the rotation of the photosensitive drum 1 stops may preferably be not more than a distance corresponding to one-full circumference of the photosensitive drum 1. As a result, it is possible to suppress a decrease again in amount of the lubricant supplied to between the photosensitive drum 1 and the first blade 6a.

### 6. Reverse Rotation Properness Control

Next, reverse rotation properness control in this embodiment will be described.

In the case where the supplying operation for supplying the toner to the first cleaning position Cd is executed immediately before the rotation of the photosensitive drum 1 stops, when a reversely rotating operation in which the photosensitive drum 1 is reversely rotated is executed when the rotation of the photosensitive drum 1 stops, the following problem arises in some instances. That is, when the photosensitive drum 1 is reversely rotated, simultaneously with removal of the foreign matter such as the paper powder sandwiched between the photosensitive drum 1 and the first blade 6a, also a part of the lubricant supplied to between the photosensitive drum 1 and the first blade 6a is removed. For that reason, when subsequent normal rotation of the photosensitive drum 1 is started, the frictional force between the photosensitive drum 1 and the first blade 6a increases. A situation that the supplying operation for supplying the toner to the first cleaning position Cd is performed after an end of the image formation is also a situation that the inconveniences such as the turning-up of the first blade 6a are liable to occur. For that reason, as described above, when the frictional force between the photosensitive drum 1 and the first blade 6a increases when the subsequent normal rotation of the photosensitive drum 1 is started, the conveniences such as the turning-up of the first blade 6a occur in some instances.

Therefore, in this embodiment, the image forming apparatus 100 employs the following constitution. That is, the image forming apparatus 100 of this embodiment includes, as the control means, the CPU 111 for executing the following first and second operations. The first operation is an operation (reversely rotating operation) in which when the image bearing member is stopped after the end of the image formation, the image bearing member is moved relative to the cleaning member in an opposite direction to the movement direction thereof in the image forming period. The second operation is an operation (discharging operation, lubricity imparting operation) in which in a non-image forming period other than the image forming period, the toner supplied to the image bearing member by the supplying means is supplied to the contact portion between the image bearing member and the cleaning member. Further, in this embodiment, in the case where the second operation is performed immediately before the image bearing member stops, i.e., after a final image before the image bearing member stops is formed, control is carried out so that the first operation (reversely rotating operation) is not executed when the image bearing member stops. In this embodiment, the first operation is executed by the CPU 111 every time when the image bearing member stops after the end of the image formation except for the case where the second operation is executed after the final image before the image bearing member stops is formed. That is, in this embodiment, as regards all the photosensitive drums 1, in principle, the CPU 111 executes the reversely rotating operation at the time of an end of every job. However, as a predetermined case (exceptional case), in the case where the supplying operation (at least one of the discharging operation and the lubricity imparting operation) for supplying the toner to the first cleaning position Cd in the post-rotation step, the reversely rotating operation immediately after the supplying operation is not executed by the CPU 111. In other words, in the case where the supplying operation (at least one of the discharging operation and the lubricity imparting operation) is executed immediately before the photosensitive drum 1 stops, the CPU 111 prohibits the reversely rotating operation after the last normal rotation of the photosensitive drum 1 stops.

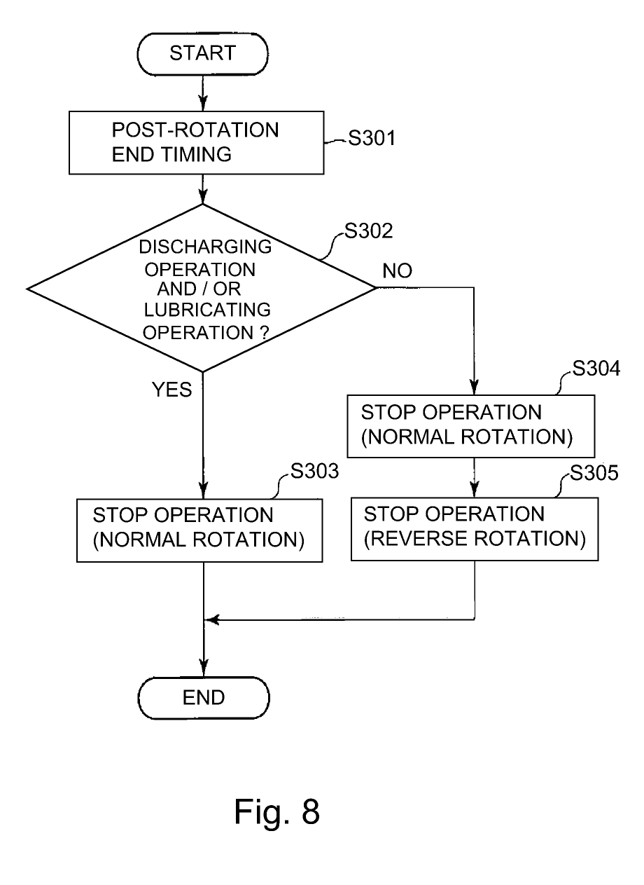

FIG. 8 is a flowchart showing an outline of a procedure of the reverse rotation properness control in this embodiment. Control of this procedure is carried out by the CPU 111 of the printer controller 209.

When timing of an operation in an operating mode in which a post-rotation step of a job is ended arrives (S301), the CPU 111 discriminates whether or not at least one of the discharging operation and the lubricity imparting operation is executed in the post-rotation step for each of the colors (S302). In the case where the CPU 111 discriminated that at least one of the discharging operation and the lubricity imparting operation is executed in S302, as regards the associated color(s), the CPU 111 causes the photosensitive drum(s) 1 to stop without performing the reversely rotating operation (S303). On the other hand, in the case where the CPU 111 discriminated that both of the discharging operation and the lubricity imparting operation are not executed in S302, as regards the associated color(s), the CPU 111 causes the photosensitive drum(s) 1 to stop normal rotation thereof (S304), and after the reversely rotating operation is executed, the CPU 111 causes the photosensitive drum (s) 1 to stop (S305).

As described above, according to this embodiment, the toner supplied by the supplying operation executed immediately before the stop of the photosensitive drum 1 can be abundantly retained at an edge portion of the first blade 6a. Accordingly, lubricity between the photosensitive drum 1 and the first blade 6a when subsequent normal rotation of the photosensitive drum 1 is started can be sufficiently ensured, so that a good cleaning performance of the first blade 6a can be continuously obtained stably. That is, even in the case where the rotation of the photosensitive drum 1 is stopped in a situation such that the image formation in a high-temperature environment or at a low print ratio is continued and thus the turning-up of the first blade 6a is liable to occur, it is possible to maintain the lubricity between the photosensitive drum 1 and the first blade 6a. As a result, the inconveniences such as the turning-f the first blade 6a can be suppressed. Further, as described above, the toner can be abundantly retained at the edge portion of the first blade 6a, so that when the normal rotation of the photosensitive drum 1 is subsequently started, the external additive, of the toner, smaller in particle size than the foreign matter such as the paper powder is preferentially supplied to the edge portion of the first blade 6a. For that reason, it is possible to suppress that the foreign matter such as the paper powder enters between the photosensitive drum 1 and the first blade 6a.

### OTHER EMBODIMENTS

The present invention was described based on the specific embodiments mentioned above, but is not limited to the above-mentioned embodiments.

In the above-described embodiments, the control in accordance with the present invention was described while paying attention to the contact portion between the photosensitive drum as the image bearing member and the cleaning blade as the cleaning member. However, the present invention is applicable when a contact portion between the image bearing member on which the toner is carried (i.e., the toner is deposited) and the cleaning member contacting the image bearing member exists. As a combination of such an image bearing member and the cleaning member, in addition to the combination between the photosensitive member and the cleaning member in the above-described embodiment, it is possible to cite a combination between the intermediary transfer member and the cleaning member and a combination between a recording material carrying member and the cleaning member. The intermediary transfer member is a second image bearing member onto which the toner image is transferred from the first image bearing member (another image bearing member) such as the photosensitive member. Further, the recording material carrying member is a second image bearing member for carrying and conveying the recording material onto which the toner image is transferred from the first image bearing member (another image bearing member) such as the photosensitive member, and fog toner is deposited on the recording material carrying member and a toner image for control is transferred onto the recording material carrying member. As the recording material carrying member, for example, a transfer belt constituted by an endless belt similar to the intermediary transfer belt in the above-described embodiment can be used. Further, as is well known in the art, in the image forming apparatus including the transfer belt, similarly as in the formation of the toner image on the intermediary transfer belt in the above-described embodiment, the toner image is formed on the recording material carried and conveyed on the transfer belt. In the case where attention is paid to the contact portion between the cleaning member and the intermediary transfer member or the recording material carrying member as the image bearing member, each of the image forming portions functions as the supplying means for supplying the toner to the image bearing member.

For example, when further description is made in accordance with the image forming apparatus 100 in the above-described embodiment, the foreign mater such as the paper powder is sandwiched between the intermediary transfer belt 7 and the second belt 74a of the belt cleaning device 74 in some instances. For that reason, execution of the reversely rotating operation of the intermediary transfer belt 7 when the intermediary transfer belt 7 is stopped is effective. Further, in the case where the image formation in the high-temperature environment or with the low image ratio is continued, the frictional force between the second blade 74a and the intermediary transfer belt 7 increases in some instances. For that reason, similarly as in the case of the first cleaning position Cd in the above-described embodiment, supply of the lubricant (external additive of the toner) to between the second blade 74a and the intermediary transfer belt 7 by appropriately supplying the toner to the second cleaning position Cb is effective. Incidentally, when this toner passes through the secondary transfer portion T2, a voltage of an opposite polarity to that applied during the secondary transfer is applied to the secondary transfer roller 8 or the second transfer roller 8 is spaced from the intermediary transfer belt 7, so that deposition of the toner on the secondary transfer roller 8 can be suppressed.

This toner supplying operation to the second cleaning position Cb can be carried out independently of the toner supplying operation to the first cleaning position Cd so that the toner in a predetermined amount is supplied to the second cleaning position Cb at predetermined timing. In this case, it is only required that the toner images formed in an arbitrary single or plurality of image forming portions S are transferred to the intermediary transfer belt 7 and then are fed to the second cleaning position Cb. Alternatively, the toner supplying operation to the first cleaning position Cd and the toner supplying operation to the second cleaning position Cb may also be executed in synchronism with each other. In this case, a part of the toner of the toner images formed in the arbitrary single or plurality of image forming portions S can be transferred to the intermediary transfer belt 7 and then can be supplied to the second cleaning position Cb and another part of the toner of the toner images can be supplied to the first cleaning position Cd. Incidentally, a surface movement distance of the intermediary transfer belt 7 from arrival of the toner images at the second cleaning position Cb until the rotation of the intermediary transfer belt 7 stops may preferably be 10 mm or more and not more than a distance corresponding to one-full circumference of the intermediary transfer belt 7 similarly as in the above-described embodiment. In addition, also the toner amount and shape of the toner images caused to reach the second cleaning position Cb can be set in accordance with the case of the above-described embodiment. Further, for example, in principle, every time when the rotation of the intermediary transfer belt 7 is stopped, the reversely rotating operation of the intermediary transfer belt 7 can be executed after the normal rotation of the intermediary transfer belt 7 is stopped. In the case where the toner supplying operation to the second cleaning position Cb is executed immediately before the intermediary transfer belt 7 is stopped, it is possible to prevent execution of the reversely rotating operation when the intermediary transfer belt 7 is stopped.

Further, in the above-described embodiment, whether or not the reversely rotating operation should be carried out was discriminated every image forming portion, but as regards the image forming portions in which the supplying operations are executed in synchronism with each other, whether or not the reversely rotating operation should be carried out in the plurality of image forming portions may also be discriminated in common. For example, in the case where the supplying operation is discriminated as being need in either of the image forming portions, in synchronism therewith, the supplying operation may also be executed in other image forming portions. Further, in the case where the supplying operation is executed immediately before the stop of the image bearing member, in all the image forming portions, the reversely rotating operation can be prevented from being executed when the image bearing member is stopped.

Further, in the above-described embodiment, from the viewpoint that the abrasion due to the friction between the photosensitive drum and the intermediary transfer belt in the case where the photosensitive drum and the intermediary transfer belt are not normally rotated or reversely rotated in synchronism with each other, the intermediary transfer belt was spaced from the photosensitive drum. However, for example, in the case where all the photosensitive drums and the intermediary transfer belt are normally rotated or reversely rotated in synchronism with each other or in the case where the friction of the intermediary transfer belt with the photosensitive drums can be permitted, there is no need to space the intermediary transfer belt from the photosensitive drums.

In the above-described embodiment, in principle, the case where the reversely rotating operation is executed every time when the image bearing member is stopped was described as an example, but the reversely rotating operation may also be executed at predetermined timing (frequency) which is set in advance. In this case, even when the timing of execution of the reversely rotating operation arrives, in the case where the supplying operation is carried out immediately before the stop of the image bearing member, control may only be required to be carried out so as to prohibit the execution of the reversely rotating operation.

In the above-described embodiment, in order to move the image bearing member relative to the cleaning member in the opposite direction to the movement direction in the image forming period, the reversely rotating operation in which the image bearing member is rotated (moved) relative to the cleaning member which is at rest at a fixed position was carried out. However, an operation such that a similar effect can be obtained by moving the image bearing member relative to the cleaning member in the opposite direction to the movement direction in the image forming period may also be employed. For example, in the same direction as the image bearing member moving in the same direction as the movement direction in the image forming period, the cleaning member may also be moved at a speed higher than a moving speed of the image bearing member. Further, relative to the image bearing member which is at rest at a fixed position, the cleaning member may also be moved so that a relative movement direction between the image bearing member and the cleaning member is opposite to that in the image forming period.

Further, the photosensitive member is not limited to the drum-shaped photosensitive member (photosensitive drum), but may also be an endless belt-shaped photosensitive member (photosensitive member belt). Further, the intermediary transfer member and the recording material carrying member are not limited to those having the endless belt shape, but may also be those having a drum shape formed by stretching a film around a frame, for example. When the image forming apparatus is of an electrostatic recording type, the image bearing member is an electrostatic recording dielectric member formed in the drum shape or in the endless belt shape.

Further, the present invention particularly suitably acts in the case where the cleaning member is the blade-shaped member, but the cleaning member is not limited to the blade-shaped member. For example, a similar effect can be expected by applying the present invention to a member such as a block-shaped (pad-shaped) member or a sheet-shaped member when execution of the reversely rotating operation for removing the foreign matter such as the photosensitive drum or execution of the supplying operation for reducing the degree of the frictional force is desired.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-134179 filed on Jul. 7, 2017, which is hereby incorporated by reference herein in its entirety.

What is claimed is:

1. An image forming apparatus comprising:
a photosensitive member;
an intermediary transfer member movable and having an endless shape;
an image forming portion configured to carry out image formation in which a toner image is formed on a surface of said photosensitive member and thereafter is primary-transferred onto a surface of said intermediary transfer member and then is secondary-transferred onto a recording material;
a cleaning blade contacting the surface of said intermediary transfer member at a contact portion and configured to remove a deposited matter deposited on the surface of said intermediary transfer member with movement of said intermediary transfer member;
a motor configured to move said intermediary transfer member by being rotationally driven, wherein said motor is capable of moving said intermediary transfer member in a normal direction in which said intermediary transfer member moves in an image forming period and in an opposite direction to the normal direction; and
an executing portion capable of executing an operation in an operating mode after an end of the image formation, wherein in the operation in the operating mode, said executing portion is capable of executing:
a supplying operation in which toner is supplied to the contact portion by primary-transferring a supplying toner image onto said intermediary transfer member moving in the normal direction after an upstreammost portion, with respect to the normal direction, of a last toner image which is primary-transferred before said intermediary transfer member stops is primary-transferred onto said intermediary transfer member,
a stopping operation in which said intermediary transfer member moving in the normal direction is stopped, and
a reversely moving operation in which said intermediary transfer member is moved in the opposite direction and then is stopped, wherein a distance of movement of said intermediary transfer member in the opposite direction is not less than a distance of the contact portion with respect to a movement direction of said intermediary transfer member,
wherein said executing portion executes the operation in the following manner depending on whether or not the supplying operation is executed:
i) when the supplying operation is not executed, after an end of the image formation, the stopping operation is executed and then the reversely moving operation is executed, and
ii) when the supplying operation is executed, after the supplying operation is carried out, the stopping operation is executed but the reversely moving operation is not executed.

2. An image forming apparatus according to claim 1, wherein during execution of the operation in the operating mode, said executing portion executes the supplying operation when a cumulative image formation number from a last supplying operation to current image formation is less than a threshold and does not execute the supplying operation when the cumulative image formation number is not less than the threshold.

3. An image forming apparatus according to claim 2, wherein said executing portion executes the supplying operation after the cumulative image formation number is not less than the threshold and before said intermediary transfer member first stops.

4. An image forming apparatus according to claim 1, further comprising a detecting member configured to detect a temperature of at least one of an inside and an outside of a main assembly of said image forming apparatus,
wherein said executing portion executes the supplying operation so that an amount of the toner supplied to the contact portion by the supplying operation when a temperature detected by said detecting member is a first temperature is larger than an amount of the toner supplied to the contact portion by the supplying operation when the temperature detected by said detecting member is a second temperature lower than the first temperature.

5. An image forming apparatus according to claim 1, wherein in the supplying operation, said executing portion causes said intermediary transfer belt to move in a distance of 10 mm or more after an upstreammost position of said intermediary transfer member with respect to the movement direction of said intermediary transfer member in a region in which the supplying toner image is formed reaches the contact portion.

6. An image forming apparatus according to claim 5, wherein a length of the region with respect to the movement direction of said intermediary transfer member is 1 mm.

7. An image forming apparatus comprising:
a movable photosensitive member;
an image forming portion configured to form an image by forming a toner image on a surface of said photosensitive member and thereafter by transferring the toner image onto a recording material;
a cleaning blade contacting the surface of said photosensitive member at a contact portion and configured to remove a deposited matter deposited on the surface of said photosensitive member with movement of said photosensitive member;
a motor configured to move said photosensitive member by being rotationally driven, wherein said motor is capable of moving said photosensitive member in a normal direction in which said photosensitive member moves in an image forming period and in an opposite direction to the normal direction; and
an executing portion capable of executing an operation in an operating mode after an end of the image formation, wherein in the operation in the operating mode, said executing portion is capable of executing:
a supplying operation in which toner is supplied to the contact portion by forming a supplying toner image on said photosensitive member moving in the normal direction after an upstreammost portion, with respect to the normal direction, of a last toner image which is primary-transferred before said photosensitive member stops is formed on said photosensitive member,
a stopping operation in which said photosensitive member moving in the normal direction is stopped, and
a reversely moving operation in which said photosensitive member is moved in the opposite direction and then is stopped, wherein a distance of movement of said photosensitive member in the opposite direction is not less than a distance of the contact portion with respect to a movement direction of said photosensitive member,
wherein said executing portion executes the operation in the following manner depending on whether or not the supplying operation is executed:
i) when the supplying operation is not executed, after an end of the image formation, the stopping operation is executed and then the reversely moving operation is executed, and
ii) when the supplying operation is executed, after the supplying operation is carried out, the stopping operation is executed but the reversely moving operation is not executed.

8. An image forming apparatus according to claim 7, wherein during execution of the operation in the operating mode, said executing portion executes the supplying operation when a cumulative image formation number from a last supplying operation to current image formation is less than a threshold and does not execute the supplying operation when the cumulative image formation number is not less than the threshold.

9. An image forming apparatus according to claim 8, wherein said executing portion executes the supplying operation after the cumulative image formation number is not less than the threshold and before said intermediary transfer member first stops.

10. An image forming apparatus according to claim 7, further comprising a detecting member configured to detect a temperature of at least one of an inside and an outside of a main assembly of said image forming apparatus,
wherein said executing portion executes the supplying operation so that an amount of the toner supplied to the contact portion by the supplying operation when a temperature detected by said detecting member is a first temperature is larger than an amount of the toner supplied to the contact portion by the supplying operation when the temperature detected by said detecting member is a second temperature lower than the first temperature.

11. An image forming apparatus according to claim 7, wherein in the supplying operation, said executing portion causes said intermediary transfer belt to move in a distance of 10 mm or more after an upstreammost position of said intermediary transfer member with respect to the movement direction of said intermediary transfer member in a region in which the supplying toner image is formed reaches the contact portion.

12. An image forming apparatus according to claim 11, wherein a length of the region with respect to the movement direction of said intermediary transfer member is 1 mm.

13. An image forming apparatus according to claim 7, wherein said image forming portion includes a charging roller contacting said photosensitive member at a charging nip and configured to electrically charge said photosensitive member and a developing device configured to deposit the toner image on said photosensitive member at a developing position,
wherein in the reversely moving operation, said executing portion sets the distance of movement of said photosensitive member in the opposite direction is shorter than a distance between the charging nip and the developing position with respect to the movement direction of said photosensitive member.
